(19) United States
(12) Patent Application Publication
(10) Pub. No.: US 2014/0172546 A1
(43) Pub. Date: Jun. 19, 2014

(54) DIGITAL PERSONALIZATION SCHEMA FOR OFFERS

(71) Applicant: Adam J. Spanky Compain, San Francisco, CA (US)

(72) Inventor: Adam J. Spanky Compain, San Francisco, CA (US)

(21) Appl. No.: 13/717,697

(22) Filed: Dec. 17, 2012

(51) Int. Cl. G06Q 30/02

(52) U.S. Cl. CPC G06Q 30/0246
USPC 705/14.45

(57) ABSTRACT

An offer identifier is generated when an end user purchases an online offer via an application module on the end user's remote client device. An offer receipt comprising the offer identifier is communicated to the purchaser, and the offer identifier is stored on the purchaser's remote client device. The offer identifier is communicated to a merchant payment system when redeeming the offer offline at the merchant's store and then communicated to the offer redemption recording system. The offer redemption recording system lists the offer identifier received from the merchant payment system as redeemed. The offer redemption recording system uses the listed offer identifiers to identify previous purchasers of online offers by searching for the matching offer identifiers on the purchaser's remote client device when the purchaser uses the application module on the remote client device to access web sites associated with an ad server.

### TECHNICAL FIELD

The present disclosure relates to systems and methods for remarketing online advertisements and offers. More particularly, the present disclosure provides systems and methods for recording the offline redemption of offers purchased online.

### BACKGROUND

Online offers and advertisements are used by merchants to drive incremental online and offline (in-store) transactions. In addition, merchants utilize remarketing to reach customers who have already shown interest in, or purchased products from, the merchant. In general, remarketing works by placing a cookie in the browser of an end user who has viewed or purchased an online offer or advertisement. When the end user visits the merchant's web site or related web sites, an ad server will utilize the cookie to identify the end user as someone who has shown interest in or purchased a given merchant's products and will display another advertisement or offer from that merchant in the end user's browser. While the online redemption of can be recorded using systems like the one described above, many offers are redeemed offline at a merchant's store, creating a gap in the ability to record offline redemptions of offers purchased online. Accordingly, merchants are not able to remarket as effectively to this valuable customer pool.

### SUMMARY

In certain example aspects described herein, a method to record offline redemption of offers purchased online using an offer redemption recording system. The offer redemption recording system communicates an offer identifier to a client computing device and stores the offer identifier in a local data structure of the client computing device in response to a purchase of an offer by a purchaser associated with the client computing device. The offer redemption recording system further communicates an offer receipt to the end user, the offer receipt comprising the offer identifier. The offer redemption recording system stores the offer identifier in an offer information storage unit. When the purchaser redeems the offer offline at a merchant's store, the offer identifier is communicated to the merchant's payment system. The merchant payment system then communicates the offer identifier to the offer redemption recording system. The offer redemption recording system stores an indication of the redemption event in an offer information storage unit. For example, the offer redemption recording system may change the status of a record associated with the offer identifier to redeemed or store the offer identifier in an index containing only offer identifiers associated with redeemed offers. An ad server can then access the offer identifiers associated with redeemed offers and use the offer identifiers to identify purchasers who have previously redeemed a merchant's offer by searching for matching offer identifiers in the local data structure of the purchaser's computing device when the application module is used to access a merchant's web site or other monitored web site. Upon identification of a matching offer identifier, the ad server displays a follow-on offer or advertisement from that merchant via the end user's application module.

These and other aspects, objects, features, and advantages of the example embodiments will become apparent to those having ordinary skill in the art upon consideration of the following detailed description of illustrated example embodiments.

### BRIEF DESCRIPTION OF THE DRAWINGS

FIG. 1 is a block diagram depicting a system for recording offline redemption of offers purchased online, in accordance with certain example embodiments.

FIG. 2 is a block flow diagram depicting a method to record offline redemption of online offers and remarket online offers to purchasers based on offline redemption of previous offers, in accordance with certain example embodiments.

FIG. 3 is a block flow diagram depicting a method to record the offline redemption of a purchased online offers using an offer redemption recording system, in accordance with certain example embodiments.

FIG. 4 is a block flow diagram depicting a method to serve follow-on offers and advertisements to purchasers who have redeemed a previously purchased offer, in accordance with certain example embodiments.

FIG. 5 is a block diagram depicting a computing machine and a module, in accordance with certain example embodiments.

### DETAILED DESCRIPTION OF THE EXAMPLE EMBODIMENTS

### Overview

The methods and systems described herein enable a merchant to record offline redemptions of merchant offers obtained online and to further remarket online advertisements and offers to users based on their redemption of previous offers. By storing an offer identifier, such as a cookie, on a user's remote client computing device, the embodiments described herein can record offline purchaser redemption behavior while maintaining the privacy of a purchaser's individual information.

The offer redemption recording system works in communication with or as part of an offer server that distributes online offers from merchants to potential purchasers. Offer refers to pre-paid offers, group offers, coupons, discounts, vouchers, and other similar items of redeemable value. Distribution of an offer refers to the process of making the details of the offer accessible to users via application modules, such as browser applications or stand-alone applications, on remote client devices. The offer includes information on a merchant's product. The term products refers to both tangible and intangible products as well as services. Remote user devices may include, but are not limited to, personal computers, mobile phones, or tablet computers. In certain example embodiments, the application module may be a dedicated shopping or offer software application resident on the remote client device.

An end user purchases or accepts an online offer using the application module on their remote client computing device. The offer redemption recording system assigns the offer an offer identifier. The offer redemption recording system stores this offer identifier in a local data structure on the remote client device. For example, the offer redemption recording system may store the offer identifier in a cookie for storage with the end user's browser application. In addition, the offer redemption recording system stores the offer identifier in an offer information storage unit, for example, a database comprising an index of offers or offer information, of the offer redemption recording system.

A user who has purchased or obtained an online offer may redeem the offer offline at the issuing merchant's store. At the time the offer is obtained, the offer purchase identifier is communicated to a merchant computing device, such as a point of sale device. For example, a barcode encoding the offer identifier may be scanned using a bar code reader in communication with a merchant point of sale device, or the offer identifier may be communicated to a merchant point of sale device using near field communication. Alternatively, the merchant may type in the offer identifier at the point of sale device. The merchant computing device then communicates a redemption notification comprising the offer identifier to the offer redemption recording system. The offer redemption recording system stores an indication of the redemption event in the offer information storage unit, and/or in a centrally managed user account, in response to receiving the offer identifier from the merchant computing device.

The offer redemption recording system may then use the offer identifiers associated with redeemed offers to serve subsequent offers and advertisements targeted to previous purchasers of an offer. For example, on web sites monitored by the offer redemption recording system, the offer redemption recording system may serve an offer or advertisement when a previous purchaser visits the monitored web page. The offer redemption recording system can identify the previous purchaser by detecting an offer identifier stored in a local data structure on the purchaser's remote client computing device, or stored in a centrally managed user account, that matches an offer identifier stored in the offer information storage unit and identified as redeemed (“redeemed offer identifier”). The offer redemption recording system can then serve a follow-up offer or advertisement to the previous purchaser after detecting that the purchaser has redeemed the previous offer based on matching the redeemed offer identifier stored on the remote client computing device, or in a centrally managed user account, and the offer information storage unit. Alternatively, the remarketing of offers and advertisements may be executed by a separate advertisement server. In that instance, the offer redemption recording system communicates the redeemed offer identifiers to the advertisement server, which monitors the web page for redeemed offer identifiers on remote client computing devices. The advertisement server can serve a follow-up offer or advertisement to the previous purchaser after detecting that the purchaser has redeemed the previous offer based on detection of a redeemed offer purchaser identifier on the remote client computing device.

Aspects of embodiments will be explained in more detail in the following description, read in conjunction with the figures illustrating the program flow.

### Example System Architectures

Turning now to the drawings, in which like numerals represent like (but not necessarily identical) elements throughout the figures, example embodiments are described in detail.

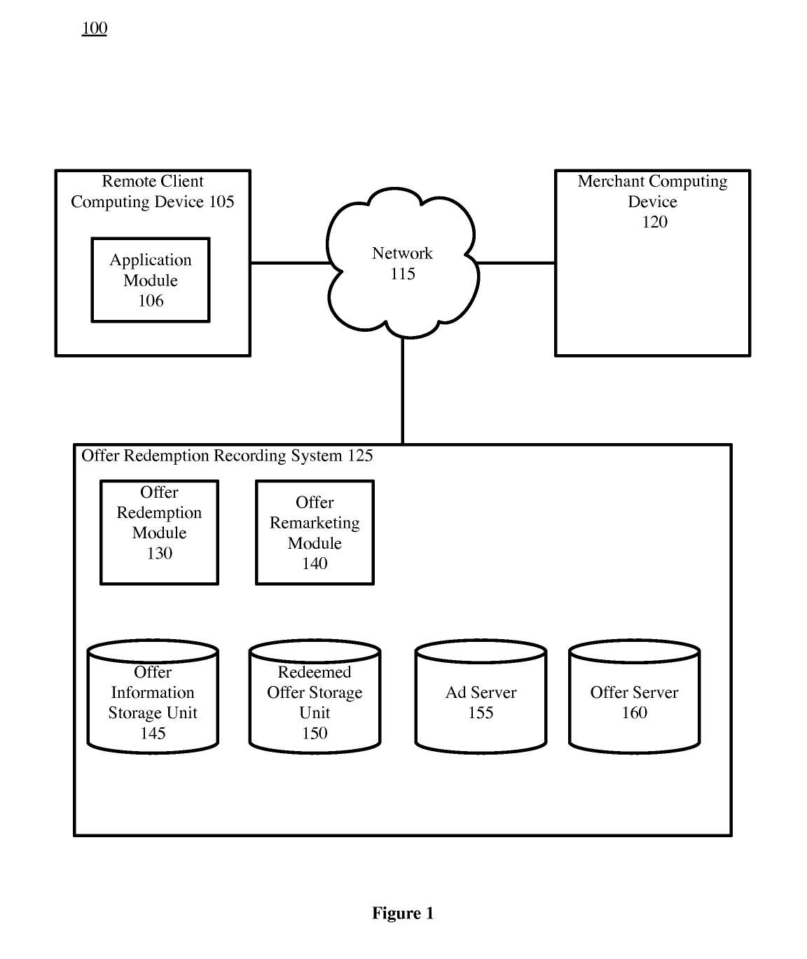

FIG. 1 is a block diagram depicting a system for recording the offline redemption of offers purchased or otherwise obtained online, in accordance with certain example embodiments. As depicted in FIG. 1, the system 100 includes network devices 105, 120, and 125 that are configured to communicate with one another via one or more networks 115.

Each network 115 includes a wired or wireless telecommunication means by which network devices (including devices 105, 120, and 125) can exchange data. The network 115 includes a wired or wireless telecommunication system or device by which network devices (including devices 105, 120, and 125) can exchange data. For example, the network 115 can include a local area network (“LAN”), a wide area network (“WAN”), an intranet, an Internet, storage area network (SAN), personal area network (PAN), a metropolitan area network (MAN), a wireless local area network (WLAN), a virtual private network (VPN), a cellular or other mobile communication network, Bluetooth, NFC, or any combination thereof or any other appropriate architecture or system that facilitates the communication of signals, data, and/or messages.

Each network device 105, 120, and 125 includes a device having a communication module capable of transmitting and receiving data over the network 115. For example, each network device 105, 120, and 125 can include a server, desktop computer, laptop computer, tablet computer, a television with one or more processors embedded therein and/or coupled thereto, smart phone, handheld computer, personal digital assistant (“PDA”), or any other wired or wireless, processor-driven device. In the example embodiment depicted in FIG. 1, the network devices 105, 120, and 125 are operated by end-users or consumers, merchant operators, and offer redemption recording system operators, respectively.

The user device 105 has an application module 106, such as a web browser application or a stand-alone application, to view, download, upload, or otherwise access documents or web pages via a distributed network 115. Throughout the discussion of example embodiments, it should be understood that the terms “data” and “information” are used interchangeably herein to refer to text, images, audio, video, or any other form of information that can exist in a computer based environment.

The merchant computing device 120, such as a point of sale device, processes consumer purchases and forms of payment, including coupons and other redeemable offers. The merchant computing device 120 is directly or indirectly in communication with the offer redemption recording system 125. The merchant computing device 120 can receive offer identifiers in electronic or hard copy forms and communicate this information to the offer redemption recording system 125.

In certain example embodiments, the offer redemption recording system 125 comprises an offer redemption recording module 130, an offer remarketing module 140, an offer information storage unit 145, an optional redeemed offer storage unit 150, an ad server 155, and an offer server 160. The offer recording module 130 tags and records redemption of offers by assigning an accepted offer an offer identifier. The offer redemption module 130 communicates an offer receipt comprising the offer identifier to the purchaser and stores the offer identifier in a local data structure on the purchaser's remote client device. The offer redemption module 130 stores the offer identifiers in an offer information storage unit 145. Offer identifiers are communicated to a merchant computing device 120 when redeemed offline by the purchaser at a merchant's store and communicated to the offer redemption tracking system 125. The offer remarketing module 140 stores an indication of the redemption event in the in the offer information storage unit 145 in response to receiving the offer identifier from a merchant computing device 120. The ad server 155 serves advertisements for display to end users on designated web sites having a purchase offer identifier stored in a local data structure on the remote client computing device 105 that matches an offer identifier stored on the offer information storage unit 145 and indicated as redeemed. The ad server 155 may serve an advertisement to a selected user based on defined presentation criteria. For example, the ad server 155 may select the advertisement to display to an end user based on information stored in an end user's application module 106. In certain example embodiments, the ad server 155 is part of the offer redemption recording system 125. In certain other example embodiments, the ad server 155 is a third-party ad server in communication with the offer redemption recording system 125.

It will be appreciated that the network connections shown are by way of example and other means of establishing a communications link between the computers and devices can be used. Moreover, those having ordinary skill in the art and having the benefit of the present disclosure will appreciate that the user device 105, merchant computing device 120 and offer redemption recording system 125 illustrated in FIG. 1 can have any of several other suitable computer system configurations.

### Example Processes

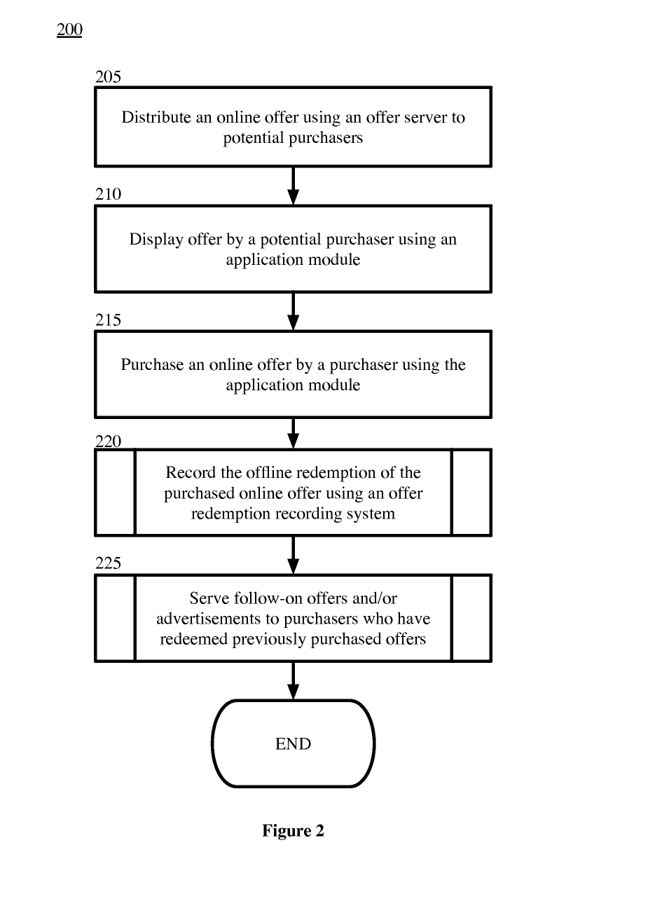

The components of the example operating environment 100 are described hereinafter with reference to the example methods illustrated in FIGS. 2 to 4.

FIG. 2 is a block flow diagram depicting a method 200 to record the offline redemption of offers accepted online and remarket online offers and advertisements to end users based on the end users' redemption of previous offers, in accordance with certain example embodiments.

Method 200 begins with block 205, where an offer server 160 distributes an online offer for display to potential purchasers. The online offer comprises a product description, the offer issuer, for example, a merchant making the offer, and an offer description. An online offer may describe the product offered and often indicate the number of purchasers needed to secure the terms of the offer. The online offer will also comprise a uniform resource locator (“URL”) for establishing a communication channel with the offer server 160. The online offer may be distributed, for example, by hosting on a web page, via email, or by social network.

At block 210, the distributed offer is displayed to an end user via an application module 106 on a remote client computing device 105 operated by the end user.

At block 215, the end user accepts an online offer via the application module 106. In example embodiments, the end user may accept an offer by purchasing the offer, if required, by clicking on an offer to obtain the offer, or by other suitable means to accept an offer presented to the end user. The example embodiments are described herein with regard to an offer that is accepted by the end user via purchasing the offer. However, the embodiments described herein include offers accepted via other means, for example, by simply clicking on an advertisement to accept an offer associated therewith.

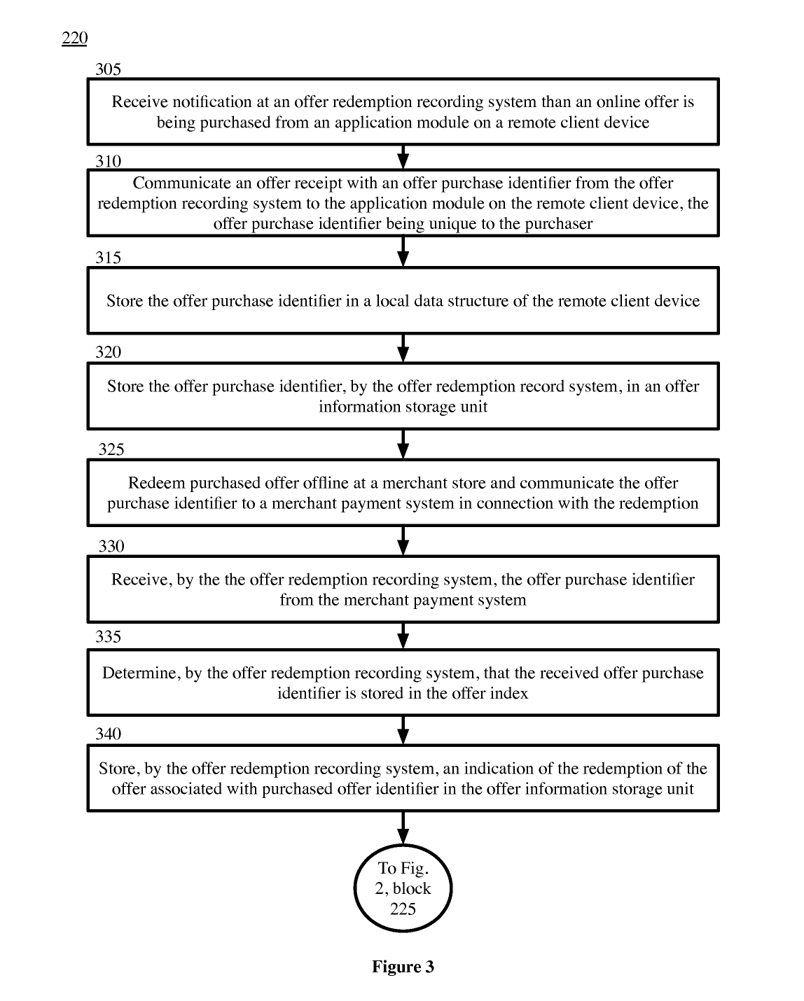

At block 220, the offer redemption recording system 125 records the offline redemption of the purchased offer. Block 220 is described in further detail hereinafter with reference to FIG. 3.

FIG. 3 is a block flow diagram depicting a method 220 to record the offline redemption of an offer purchased online using an offer redemption recording system, in accordance with certain example embodiments.

Method 220 begins at block 305, where the offer redemption module 130 receives a notification that an online offer is being purchased from an application module 106 on a remote client device 105. For example, the offer server 160, or a payment module associated with the offer server 160, may communicate the purchase notification to the offer redemption module 130. In certain other example embodiments, the notification may be received from the remote client computing device 105 from which the offer was purchased.

At block 310, the offer redemption module 130 communicates an offer receipt to the application module 106 on the purchaser's remote client device 105 in response to receiving the purchase notification. The offer receipt comprises an offer identifier assigned by the offer redemption module 130 to the purchased offer. The offer identifier is unique to the purchaser. In certain example embodiments, the offer redemption module 130 assigns the offer identifier by appending a unique identifier to an offer identifier previously associated with the purchased offer. For example, an identifier may be assigned to the offer when it is generated by the offer server 160 prior to distribution to potential purchasers. In other example embodiments, the offer redemption module 130 generates a unique purchase offer identifier that does not incorporate any offer identifier previously signed to the purchased offer.

In certain example embodiments, the offer receipt may be communicated to the same application module 106 used to display the purchased offer, or to a second application module 106. For example, the online offer may have originally been displayed to the purchaser using a browser application and the offer receipt communicated to an email client application module.

At block 315, the offer redemption module 130 stores the offer identifier in a local data structure on the remote client device 105. For example, the local data structure may be a local data structure associated with the application module 106, such as a cookie, or HTML 5 local storage.

At block 320, the offer redemption module 130 stores the offer identifier in an offer information storage unit 145.

At block 325, the purchaser of the online offer redeems the offer offline at a merchant's store by communicating the offer identifier to a merchant computing device 120. The offer identifier may be communicated by scanning a barcode displayed on the screen of the purchaser's remote client device 105, or on a printed piece of paper. In certain example embodiments, the offer identifier is communicated to the merchant computing device 120 using near field communication (NFC). In certain other example embodiments, the offer identifier is keyed in to the merchant computing device 120 by hand.

At block 330, the offer redemption module 130 receives the offer identifier from the merchant computing device 120.

At block 335, the offer redemption module 130 determines if a matching offer identifier is stored in the offer information storage unit 145.

At block 340, the offer redemption module 130 stores an indication of the redemption event in the offer information storage unit 145. One example of an indication of the redemption event is “flagging” the offer identifier in the offer information storage unit. Flagging an offer identifier may mean changing the status of a field in an offer record stored in the offer redemption storage unit 145 to redeemed, storing the offer identifier in a separate index or table within the offer information storage unit 145 for offer identifiers associated with redeemed offers, or storing the redeemed offer identifier in a separate offer redemption storage unit 150.

In certain other example embodiments, the offer redemption module 130 may generate both an offer identifier and an offer redemption identifier. The offer identifier is stored in a local data structure on the purchaser's remote client computing device 105 as described with reference to block 315. The offer redemption identifier is included in the offer receipt instead of the offer identifier as described at block 310. The offer redemption module 130 stores the offer identifier and the offer redemption identifier together in the offer information storage unit 145 as described at block 320. When a purchaser of the offer redeems the offer offline, the offer redemption identifier is communicated to the merchant computing device 120 as described at block 325, and the offer redemption module 130 receives the offer redemption identifier from the merchant computing device 120 as described at block 330. The offer redemption module 130 uses the offer redemption identifier to look up the corresponding offer identifier stored in the offer information storage unit 145. If the offer redemption module 130 determines there is an offer identifier corresponding to the offer redemption identifier in the offer information storage unit 145, the offer redemption module 130 stores an indication of the redemption event in the offer information storage unite 145 as described at block 340.

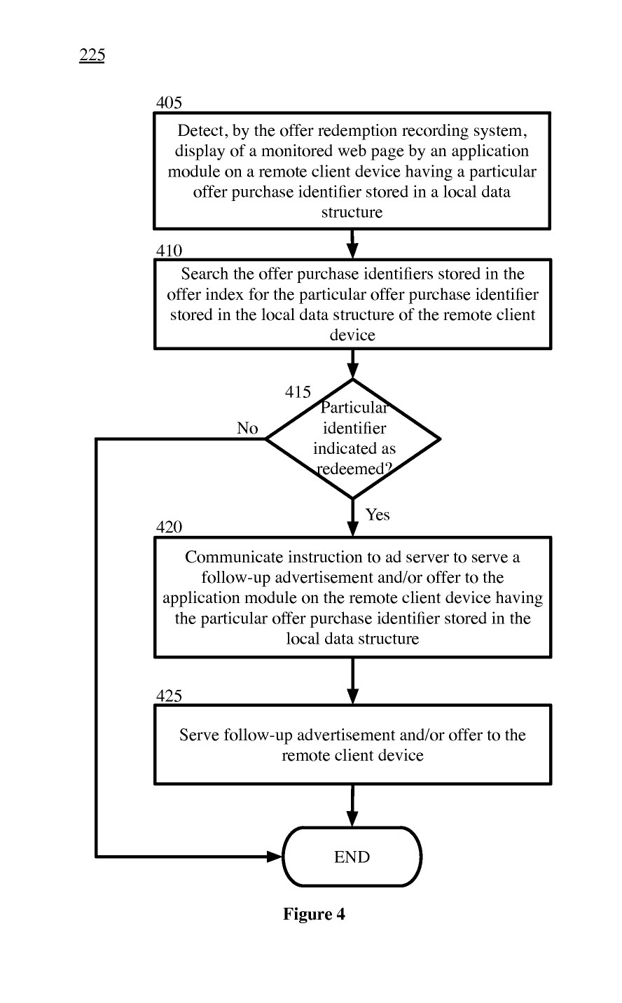

Returning to FIG. 2 at block 225, where the ad server 155 serves follow-on offers or advertisements to remote client devices 105. Block 225 is described in further detail hereinafter with reference to FIG. 4.

FIG. 4 is a block flow diagram depicting a method 225 to serve follow-on offers and advertisements to purchasers who have redeemed previously purchased offers, in accordance with certain example embodiments.

Method 225 begins at block 405, where an offer remarketing module 140 detects display of a monitored web page by an application module 106 on a remote client device 105 having an offer identifiers stored in a local data structure on the remote client device 105. For example, a monitored web page may include a web page encoded to load select advertisements or offers based on information stored in a local data structure, such as a cookie, on a remote client device 105.

At block 410, the offer remarketing module 140 searches the offer identifiers stored in the offer information storage unit 145 and identified as redeemed, or stored in the redeemed offer storage unit 150, for the particular offer identifier stored in the local data structure of the remote client device 105.

At block 415, the offer remarketing module 140 determines if the offer identifier stored on the remote client computing device 105 matches an offer identifier stored in the offer information storage unit 145 and identified as redeemed, or stored in the redeemed offer storage unit 150. If the offer identifier in the local data structure of the remote client device 105 is not found or is not identified as redeemed in the offer information storage unit 145, or is not stored in the redeemed offer storage unit 150, the method terminates. If the offer identifier in the local data structure of the remote client device 105 matches an offer identifier identified as redeemed in the offer information storage unit 145, or stored in the redeemed offer storage unit 150, the method proceeds to block 420.

At block 420, the offer remarketing module 140 communicates an instruction to an ad server 155 or an offer server 160 to display a follow-on advertisement or offer via the application module 106 on the remote client device 105. Follow-on advertisements and offers may be selected from a pool of follow-on advertisements and offers directed to previous redeemers of an online offer. The terms of the advertisement or offer may be selected based on additional information stored in the local data structure of the remote client computing device 105 by the offer redemption recording system. For example, the offer redemption recording system may store such information as the location of the merchant store where the offer was redeemed, the value of the previous offer, and the delay between purchasing the offer and redeeming the offer.

At block 425, the ad server 155 or offer server 160 serves the follow-on advertisement or offer to the web server hosting the monitored web page for display on the application module 106 on the remote client device 105.

In certain alternative example embodiments, the ad server 155 detects the display of a monitored web page by an application module 106 on a remote client device 105 having a particular offer identifier stored in a local data structure as described in block 405, searches the offer identifiers stored in the offer information storage unit 145 or redeemed offer storage unit 150 for the particular offer identifier stored in the local data structure as described at block 410, and determines if the particular offer identifier matches an offer identifier identified as redeemed in the offer information storage unit 145, or stored in the redeemed offer storage unit 150 as described in block 415. Accordingly, in such example embodiments, instructions from an offer remarketing module 140 to the ad server 155 as described in block 420 are not necessary for the ad server 155 to serve the follow-on advertisement or offer to the application module 106 on the remote client device 105.

In certain example embodiments, the offer identifier is stored in a purchaser's centrally managed account instead of, or in addition to, storing the offer identifier in a local data structure on the purchaser's remote computing device 105. For example, the offer identifier may be stored in a record associated with a purchaser's centrally managed email account or other web or application service account. The offer remarketing module 140 can search the purchaser's centrally managed account as described in block 415 to identify an offer identifier that is stored in the purchaser's centrally managed account and that is identified as redeemed in the offer information storage unit 145 and/or the redeemed offer storage unit 150. Then, the process proceeds substantially as described in blocks 420 and 425 to presents a follow-up advertisement and/or offer to the purchaser associated with the purchaser's centrally managed account. In addition, to serving the follow-up advertisement or offer via a web site being viewed by the purchaser, the follow-up advertisement or offer may be sent via email to the purchaser's email account or via other suitable communication. In example embodiments, the offer recording system 125 or other remote computing device or system may manage the centrally managed user accounts for multiple purchasers.

### Other Example Embodiments

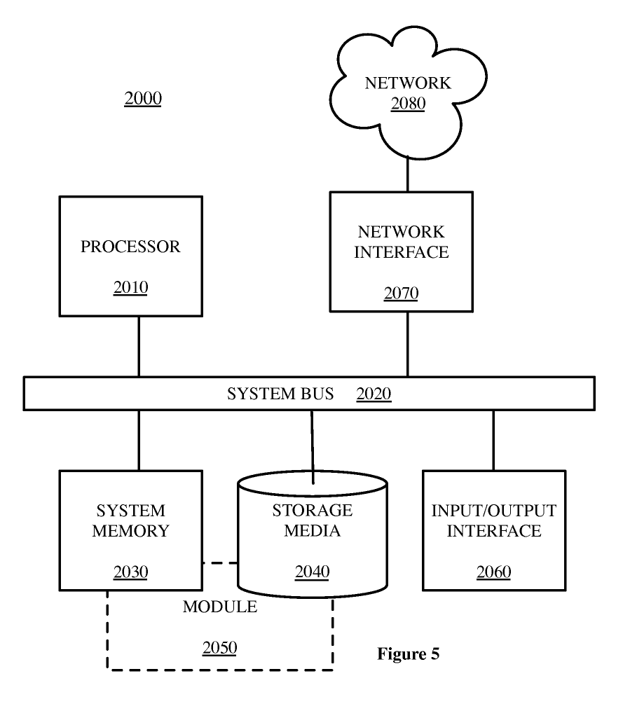

FIG. 5 depicts a computing machine 2000 and a module 2050 in accordance with certain example embodiments. The computing machine 2000 may correspond to any of the various computers, servers, mobile devices, embedded systems, or computing systems presented herein. The module 2050 may comprise one or more hardware or software elements configured to facilitate the computing machine 2000 in performing the various methods and processing functions presented herein. The computing machine 2000 may include various internal or attached components such as a processor 2010, system bus 2020, system memory 2030, storage media 2040, input/output interface 2060, and a network interface 2070 for communicating with a network 2080.

The computing machine 2000 may be implemented as a conventional computer system, an embedded controller, a laptop, a server, a mobile device, a smartphone, a set-top box, a kiosk, a vehicular information system, one more processors associated with a television, a customized machine, any other hardware platform, or any combination or multiplicity thereof. The computing machine 2000 may be a distributed system configured to function using multiple computing machines interconnected via a data network or bus system.

The processor 2010 may be configured to execute code or instructions to perform the operations and functionality described herein, manage request flow and address mappings, and to perform calculations and generate commands. The processor 2010 may be configured to monitor and control the operation of the components in the computing machine 2000. The processor 2010 may be a general purpose processor, a processor core, a multiprocessor, a reconfigurable processor, a microcontroller, a digital signal processor (“DSP”), an application specific integrated circuit (“ASIC”), a graphics processing unit (“GPU”), a field programmable gate array (“FPGA”), a programmable logic device (“PLD”), a controller, a state machine, gated logic, discrete hardware components, any other processing unit, or any combination or multiplicity thereof. The processor 2010 may be a single processing unit, multiple processing units, a single processing core, multiple processing cores, special purpose processing cores, co-processors, or any combination thereof. According to certain embodiments, the processor 2010 along with other components of the computing machine 2000 may be a virtualized computing machine executing within one or more other computing machines.

The system memory 2030 may include non-volatile memories such as read-only memory (“ROM”), programmable read-only memory (“PROM”), erasable programmable read-only memory (“EPROM”), flash memory, or any other device capable of storing program instructions or data with or without applied power. The system memory 2030 may also include volatile memories such as random access memory (“RAM”), static random access memory (“SRAM”), dynamic random access memory (“DRAM”), synchronous dynamic random access memory (“SDRAM”). Other types of RAM also may be used to implement the system memory 2030. The system memory 2030 may be implemented using a single memory module or multiple memory modules. While the system memory 2030 is depicted as being part of the computing machine 2000, one skilled in the art will recognize that the system memory 2030 may be separate from the computing machine 2000 without departing from the scope of the subject technology. It should also be appreciated that the system memory 2030 may include, or operate in conjunction with, a non-volatile storage device such as the storage media 2040.

The storage media 2040 may include a hard disk, a floppy disk, a compact disc read only memory (“CD-ROM”), a digital versatile disc (“DVD”), a Blu-ray disc, a magnetic tape, a flash memory, other non-volatile memory device, a solid sate drive (“SSD”), any magnetic storage device, any optical storage device, any electrical storage device, any semiconductor storage device, any physical-based storage device, any other data storage device, or any combination or multiplicity thereof. The storage media 2040 may store one or more operating systems, application programs and program modules such as module 2050, data, or any other information. The storage media 2040 may be part of, or connected to, the computing machine 2000. The storage media 2040 may also be part of one or more other computing machines that are in communication with the computing machine 2000 such as servers, database servers, cloud storage, network attached storage, and so forth.

The module 2050 may comprise one or more hardware or software elements configured to facilitate the computing machine 2000 with performing the various methods and processing functions presented herein. The module 2050 may include one or more sequences of instructions stored as software or firmware in association with the system memory 2030, the storage media 2040, or both. The storage media 2040 may therefore represent examples of machine or computer readable media on which instructions or code may be stored for execution by the processor 2010. Machine or computer readable media may generally refer to any medium or media used to provide instructions to the processor 2010. Such machine or computer readable media associated with the module 2050 may comprise a computer software product. It should be appreciated that a computer software product comprising the module 2050 may also be associated with one or more processes or methods for delivering the module 2050 to the computing machine 2000 via the network 2080, any signal-bearing medium, or any other communication or delivery technology. The module 2050 may also comprise hardware circuits or information for configuring hardware circuits such as microcode or configuration information for an FPGA or other PLD.

The input/output (“I/O”) interface 2060 may be configured to couple to one or more external devices, to receive data from the one or more external devices, and to send data to the one or more external devices. Such external devices along with the various internal devices may also be known as peripheral devices. The I/O interface 2060 may include both electrical and physical connections for operably coupling the various peripheral devices to the computing machine 2000 or the processor 2010. The I/O interface 2060 may be configured to communicate data, addresses, and control signals between the peripheral devices, the computing machine 2000, or the processor 2010. The I/O interface 2060 may be configured to implement any standard interface, such as small computer system interface (“SCSI”), serial-attached SCSI (“SAS”), fiber channel, peripheral component interconnect (“PCI”), PCI express (PCIe), serial bus, parallel bus, advanced technology attached (“ATA”), serial ATA (“SATA”), universal serial bus (“USB”), Thunderbolt, FireWire, various video buses, and the like. The I/O interface 2060 may be configured to implement only one interface or bus technology. Alternatively, the I/O interface 2060 may be configured to implement multiple interfaces or bus technologies. The I/O interface 2060 may be configured as part of, all of, or to operate in conjunction with, the system bus 2020. The I/O interface 2060 may include one or more buffers for buffering transmissions between one or more external devices, internal devices, the computing machine 2000, or the processor 2010.

The I/O interface 2060 may couple the computing machine 2000 to various input devices including mice, touch-screens, scanners, biometric readers, electronic digitizers, sensors, receivers, touchpads, trackballs, cameras, microphones, keyboards, any other pointing devices, or any combinations thereof The I/O interface 2060 may couple the computing machine 2000 to various output devices including video displays, speakers, printers, projectors, tactile feedback devices, automation control, robotic components, actuators, motors, fans, solenoids, valves, pumps, transmitters, signal emitters, lights, and so forth.

The computing machine 2000 may operate in a networked environment using logical connections through the network interface 2070 to one or more other systems or computing machines across the network 2080. The network 2080 may include wide area networks (WAN), local area networks (LAN), intranets, the Internet, wireless access networks, wired networks, mobile networks, telephone networks, optical networks, or combinations thereof The network 2080 may be packet switched, circuit switched, of any topology, and may use any communication protocol. Communication links within the network 2080 may involve various digital or an analog communication media such as fiber optic cables, free-space optics, waveguides, electrical conductors, wireless links, antennas, radio-frequency communications, and so forth.

The processor 2010 may be connected to the other elements of the computing machine 2000 or the various peripherals discussed herein through the system bus 2020. It should be appreciated that the system bus 2020 may be within the processor 2010, outside the processor 2010, or both. According to some embodiments, any of the processor 2010, the other elements of the computing machine 2000, or the various peripherals discussed herein may be integrated into a single device such as a system on chip (“SOC”), system on package (“SOP”), or ASIC device.

In situations in which the systems discussed here collect personal information about users, or may make use of personal information, the users may be provided with a opportunity to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

Embodiments may comprise a computer program that embodies the functions described and illustrated herein, wherein the computer program is implemented in a computer system that comprises instructions stored in a machine-readable medium and a processor that executes the instructions. However, it should be apparent that there could be many different ways of implementing embodiments in computer programming, and the embodiments should not be construed as limited to any one set of computer program instructions. Further, a skilled programmer would be able to write such a computer program to implement an embodiment of the disclosed embodiments based on the appended flow charts and associated description in the application text. Therefore, disclosure of a particular set of program code instructions is not considered necessary for an adequate understanding of how to make and use embodiments. Further, those skilled in the art will appreciate that one or more aspects of embodiments described herein may be performed by hardware, software, or a combination thereof, as may be embodied in one or more computing systems. Moreover, any reference to an act being performed by a computer should not be construed as being performed by a single computer as more than one computer may perform the act.

The example embodiments described herein can be used with computer hardware and software that perform the methods and processing functions described previously. The systems, methods, and procedures described herein can be embodied in a programmable computer, computer-executable software, or digital circuitry. The software can be stored on computer-readable media. For example, computer-readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (FPGA), etc.

The example systems, methods, and acts described in the embodiments presented previously are illustrative, and, in alternative embodiments, certain acts can be performed in a different order, in parallel with one another, omitted entirely, and/or combined between different example embodiments, and/or certain additional acts can be performed, without departing from the scope and spirit of various embodiments. Accordingly, such alternative embodiments are included in the inventions described herein.

Although specific embodiments have been described above in detail, the description is merely for purposes of illustration. It should be appreciated, therefore, that many aspects described above are not intended as required or essential elements unless explicitly stated otherwise. Modifications of, and equivalent components or acts corresponding to, the disclosed aspects of the example embodiments, in addition to those described above, can be made by a person of ordinary skill in the art, having the benefit of the present disclosure, without departing from the spirit and scope of embodiments defined in the following claims, the scope of which is to be accorded the broadest interpretation so as to encompass such modifications and equivalent structures.

What is claimed is:

1. A computer-implemented method to record offline redemptions of online offer acceptances, comprising:
communicating, using the one or more computing devices, an offer identifier to a client computing device that is associated with a user that accepted the offer via the client computing device, the client computing device being remote from the one or more computing devices, the offer identifier being communicated for storing in the client computing device;
storing, using the one or more computing devices, the offer identifier in an offer information storage unit associated with the one or more computing devices;
receiving, using the one or more computing devices, the offer identifier from a merchant computing device associated with a merchant that redeemed the offer, the offer identifier having been received by the merchant computing device in connection with an offline redemption of the offer by the user that accepted the offer, receipt of the offer identifier from the merchant computing device indicating an offline redemption of the offer by the user;
storing, using the one or more computing devices, an indication of the offline redemption of the offer associated with the offer identifier in the offer information storage unit, based at least in part on receiving the offer identifier from the merchant computing device associated with the merchant that redeemed the offer;
determining, using the one or more computing devices, that the offer identifier stored in the client computing device matches the offer identifier having the indication of the offline redemption of the offer; and
communicating, using the one or more computing devices, one or more advertisements or offers to the client computing device in response to determining that the offer identifier stored in the client computing device matches the offer identifier having the indication of the offline redemption of the offer.

2. The method of claim 1, wherein communicating one or more advertisements or offers to the client computing device comprises communicating the offer identifier having the indication of the offline redemption of the offer associated with the offer identifier to an advertisement server, the advertisement server communicating the one or more online advertisements to the client computing device.

3. The method of claim 1, wherein the determining step comprises searching a local data structure of an application module of the client computing device when the application module accesses a monitored web site.

4. The method of claim 3, wherein the local data structure is a cookie or HTML 5 local storage.

5. The method of claim 3, wherein the application module is a browser application.

6. The method of claim 1, wherein the merchant computing device receives the offer identifier stored on the client computing device by manually inputting the offer identifier into the merchant computing device

7. The method of claim 1, wherein the merchant computing device receives the offer identifier stored on the client computing device in connection by electronically capturing the offer identifier by the merchant computing device.

8. The method of claim 1, further comprising communicating the offer identifier of the offer having the indication of the offline redemption of the offer to a computing device associated with an advertisement distribution system.

9. A computer program product, comprising:
a non-transitory computer-executable storage device having computer-executable program instructions embodied thereon that when executed by a computer cause the computer to perform a method to record offline redemptions of online offer acceptances, the computer-executable instructions comprising:
computer-executable program instructions to indicate that an offer having an offer identifier has been accepted via an online acceptance;
computer-executable program instructions to receive the offer identifier of the accepted offer from a merchant computing device associated with a merchant that redeemed the offer, the offer identifier of the accepted offer having been received by the merchant computing device in connection with an offline redemption of the offer, receipt of the offer identifier from the merchant computing device indicating redemption of the offer; and
computer-executable program instructions to associate an indication of the offline redemption of the offer with the indication of the online acceptance of the offer, based at least in part on receiving the offer identifier from the merchant computer device associated with the merchant that redeemed the offer.

10. The computer program product of claim 9, further comprising:
computer-executable program instructions to determine that a client computing device has stored therein an offer identifier matching the offer identifier of the offer having the indication of the offline redemption of the offer associated with the indication of the online acceptance of the offer; and
computer-executable program instructions to communicate one or more advertisements or offers to the client computing device in response to determining the client computing device has stored therein the offer identifier matching the offer identifier of the offer having the indication of the offline redemption of the offer associated with the indication of the online acceptance of the offer.

11. The computer program product of claim 10, wherein communicating one or more advertisements or offers to the client computing device comprises, communicating the offer identifier matching the offer identifier of the offer having the indication of the offline redemption of the offer associated with the indication of the online acceptance of the offer to an advertisement server, the advertisement server communicating the one or more online advertisements to the client computing device.

12. The computer program product of claim 10, wherein determining that the client computing device has stored therein the offer identifier matching the offer identifier of the offer having the indication of the offline redemption of the offer associated with the indication of the online acceptance of the offer comprises, searching a local data structure of an application module of the client computing device when the application module accesses a monitored web site.

13. The computer program product of claim 12, wherein the local data structure is a cookie or HTML 5 local storage.

14. The computer program product of claim 12, wherein the application module is a browser application.

15. The computer program product of claim 10, wherein the merchant computing device receives the offer identifier of the offer having an indication of the online acceptance associated therewith by being manually input into the merchant computing device.

16. The computer program product of claim 10, wherein the merchant computing device receives the offer identifier of the offer having the indication of the online acceptance of the offer associated therewith by being captured electronically by the merchant computing device.

17. A system to record offline redemptions of online offer acceptances, comprising:
a storage device;
a network communication device; and
a processor communicatively coupled to the storage device and the network communication device, wherein the processor executes application code instructions that are stored in the storage device and that cause the system to:
communicate an offer identifier to a client computing device that is associated with a user that accepted the offer via the client computing device, the client computing device being remote from the one or more computing devices, the offer identifier being communicated for storing in the client computing device;
receive the offer identifier from a merchant computing device associated with a merchant that redeemed the offer, the offer identifier having been received by the merchant computing device in connection with an offline redemption of the offer by the user that accepted the offer, receipt of the offer identifier from the merchant computing device indicating the offline redemption of the offer;
associate an indication of the offline redemption of the offer, based at least in part on receiving the offer identifier from the merchant computing device associated with the merchant that redeemed the offer;
determine that the client computing device has stored therein an offer identifier matching the offer identifier of the offer having the indication of the offline redemption associated therewith; and
communicate one or more advertisements or offers to the client computing device in response to determining that the client computing device has stored therein an offer identifier matching the offer identifier of the offer having the indication of the offline redemption of the offer associated therewith.

18. The system of claim 17, wherein communicating the one or more advertisements or offers to the client computing device comprises communicating the offer identifier matching the offer identifier of the offer having the indication of the offline redemption of the offer associated therewith to an advertisement server, the advertisement server communicating the one or more online advertisements or offers to the client computing device.

19. The system of claim 17, wherein determining that the offer identifier stored in the client computing device matches the offer identifier of the offer identifier of the offer having the indication of the offline redemption associated therewith, comprises searching a local data structure of an application module of the client computing device when the application module accesses a monitored web site.

20. The system of claim 19, wherein the local data structure is a cookie or HTML 5 local storage.

21. The system of claim 19, wherein the application module is a browser application.

22. The system of claim 17, wherein the merchant computing device receives the offer identifier stored on the client computing device by manually inputting the offer identifier into the merchant computing device.

23. The system of claim 17, wherein the merchant computing device receives the offer identifier stored on the client computing device by being captured electronically by the merchant computing device.
